(19) United States
(12) Patent Application Publication
(10) Pub. No.: US 2006/0115716 A1
(43) Pub. Date: Jun. 1, 2006

(54) Battery module

(76) Inventors: Tae-Yong Kim, Suwon-si (KR); Gun-Goo Lee, Suwon-si (KR); Yoon-Cheol Jeon, Suwon-si (KR)

Correspondence Address: LEE & MORSE, P.C., SUITE 2000, 1101 WILSON BOULEVARD, ARLINGTON, VA, 22209, US

(21) Appl. No.: 11/285,289

(22) Filed: Nov. 23, 2005

(30) Foreign Application Priority Data
Nov. 30, 2004 (JP) 10-2004-0099307

(51) Int. Cl. H01M 10/50

(52) U.S. Cl. 429/120; 429/156

(57) ABSTRACT

A battery module including at least one battery column in which a plurality of unit batteries are laminatedly arranged, and a housing in which battery columns are disposed and a cooling medium is circulated. The battery columns are arranged at an angle with respect to an inflow direction of the cooling medium into the housing.

### BACKGROUND OF THE INVENTION

1. Technical Field

The present invention relates to a battery module. More particularly, the present invention relates to battery module suitable for use as a secondary battery module and including a plurality of unit batteries arranged so as to reduce the overall volume of the battery module and improve the cooling efficiency thereof.

2. Related Art

As generally recognized in the art, a primary battery is not rechargeable and a secondary battery is rechargeable, i.e., capable of being repeatedly charged and discharged. A low-capacity secondary battery may be used as a power source for portable electronic devices, e.g., cellular phones, notebook computers, camcorders, etc. A high-capacity secondary battery may be used as a power source for larger applications, e.g., powering a motor of a hybrid electric vehicle (HEV).

Secondary batteries may be manufactured in various shapes. Typically, secondary batteries may be classified as cylindrical or prismatic, depending on the external shape thereof.

High-capacity secondary batteries may be required for situations in which large amounts of power must be provided. Such high-capacity secondary batteries may be constructed by assembling and electrically connecting a plurality of unit secondary batteries, e.g., by connecting them in series, in parallel, or in a combination of the two.

Unit batteries, and batteries assembled from a plurality of unit batteries, may both be referred to by the term “batteries.” For clarity, the description that follows will distinguish between the two by referring to individual batteries as “unit batteries” and referring to assemblies of unit batteries as “modules.”

A unit battery typically includes an electrode group having a positive electrode, a negative electrode, and a separator interposed therebetween, a case having a space for accommodating the electrode group, a cap assembly combined with the case to seal the case, and positive and negative terminals protruding upward from the cap assembly and electrically connected to a collector of the positive electrode and the negative electrode provided in the electrode group.

A high-capacity battery module may include a plurality of unit batteries, which are often connected in series. In the battery module, the unit batteries may be arranged such that the positive electrode terminal and the negative terminal of a first unit battery are arranged so as to be reversed with respect to the positive terminal and the negative terminal of an adjacent second unit battery. Conductors may be provided between the positive terminal of the first battery and the negative terminal of the second battery to form the battery module.

A battery module may include several unit batteries or more, e.g., up to several tens of unit batteries. In view of the many unit batteries that may be included in the battery module, the volume of the battery module may increase to a degree that makes it unsuitable for the intended application. Further, the battery module, particularly in the case of a secondary battery module, may also require a cooling structure for radiating heat generated from the respective unit batteries, a safety means, and a system circuit. Accordingly, the battery module may become quite large.

Moreover, when the battery module is a secondary battery designed to be used as a power source for driving a motor of an electric vehicle, the number of unit batteries may be significant. In this case, the unit batteries may be arranged in a plurality of columns, thereby making it difficult to minimize the size of the battery module and also impacting the efficiency of cooling the respective unit batteries.

In a battery module in which batteries are arranged in a plurality of columns, each battery column may be arranged in a multilayer structure, or the batteries may be arranged parallel to each other on the same surface. However, when the battery columns are arranged in a multilayer structure, the height of the battery module must be increased.

If the battery columns are arranged parallel to each other, the size of the battery module may be reduced. However, the cooling efficiency of the unit batteries may suffer. More specifically, difficulties in providing uniform cooling may result in temperature differences between the respective unit batteries. For example, if the unit batteries are disposed in columns and the columns are arranged in parallel, such that a cooling medium, e.g., air, flows across one column and then across another, the latter column may not be cooled to the same degree as the former column due to heating of the air. Therefore, significant temperature differences may exist between a unit battery of the former battery column and a unit battery of the latter battery column.

If temperature differences exist between the respective unit batteries, the efficiency of discharging (or, in the case of secondary batteries, charging and discharging) may deteriorate. Further, temperature increases inside the battery module caused by heat generated in the respective unit batteries may cause performance to deteriorate. For example, in the case of a high-capacity secondary battery module used as a power source for driving a motor, the secondary battery module may be charged and discharged using high currents, resulting in the generation of heat inside the secondary battery module and associated significant temperature increases. Thus, the heat affects the secondary battery module and may degrade performance thereof to a level significantly below its nominal specification.

Therefore, there is a need for a second battery module that minimizes an overall volume of the secondary battery module while maintaining or improving cooling efficiency.

### SUMMARY OF THE INVENTION

The present invention is therefore directed to a battery module that substantially overcomes one or more of the problems due to the limitations and disadvantages of the related art.

It is therefore a feature of an embodiment of the present invention to provide a battery module having an arrangement of unit batteries that allows for improved cooling.

It is therefore another feature of an embodiment of the present invention to provide a battery module having an arrangement of unit batteries that allows for improved cooling while minimizing the size of the battery module.

At least one of the above and other features and advantages of the present invention may be realized by providing a battery module including a housing and a battery column disposed in the housing, wherein the housing includes a cooling medium inlet and a cooling medium outlet, the battery column includes a plurality of unit batteries and at least one cooling medium flow path, and the battery column is arranged at an angle with respect to the cooling medium inlet.

The unit batteries may be spaced apart and have the cooling medium flow path disposed therebetween. The battery column may include at least three unit batteries and at least two cooling medium flow paths arranged alternately, such that the unit batteries and the cooling medium flow paths form a column that includes alternating unit batteries and cooling medium flow paths. The battery column may be disposed between the cooling medium inlet and the cooling medium outlet, such that any cooling medium flowing from the cooling medium inlet to the cooling medium outlet must flow through the at least one cooling medium flow path. The battery module may further include battery partition walls disposed between each of the plurality of unit batteries. The battery columns may be disposed on a same surface. The battery columns may be disposed between and may be in contact with two opposing surfaces of the housing. The cooling medium outlet may have a size corresponding to a distance between an inner wall of the housing and a corner of the battery column.

The battery module may further include a second battery column, wherein the two battery columns are disposed inclined towards each other. An angle between the battery columns may be in the range of about 50 to about 170°. Each battery column may have a first end and a second end, the first ends of the battery columns may be spaced farther apart than the second ends of the battery columns, and the cooling medium inlet may be disposed adjacent to and between the first ends of the battery columns. The cooling medium inlet may have a first dimension approximately equal to the space between the first ends of the battery columns.

The battery module may further include a second cooling medium outlet, wherein the two cooling medium outlets may have the two battery columns disposed therebetween, and each battery column may be disposed between a cooling medium outlet and the cooling medium inlet, such that any cooling medium flowing from the cooling medium inlet to either of the two cooling medium outlets may flow through at least one of the battery columns. The second ends of the two battery columns may be disposed directly adjacent to each other. The second ends of the two battery columns may be disposed apart from each other by a first distance. The unit battery may be a prismatic battery.

At least one of the above and other features and advantages of the present invention may also be realized by providing a battery module including a stacked battery element disposed in a housing, wherein the stacked battery element may have a substantially rectangular cross section, the cross section having a height and a width, and may include a plurality of unit batteries, and cooling paths disposed between adjacent unit batteries, the housing may enclose the stacked battery element and may include first and second inner surfaces disposed adjacent to opposing surfaces of the cross section and separated by the height, third and fourth inner surfaces normal to the first and second inner surfaces and separated by a distance that is larger than the width, and an inlet and an outlet, and the stacked battery element may be disposed between the inlet and the outlet, such that a cooling medium flow path is defined between the inlet and the outlet and traverses the stacked battery element through the cooling paths.

The stacked battery element may be disposed at an angle in the housing such that the cooling medium flow path traversing the stacked battery element through the flow paths does not form a straight line between the inlet and the outlet. The housing may further include a second outlet, the battery module may further include a second stacked battery element disposed in the housing and arranged at an angle to the other stacked battery element, and a second flow path may be defined between the inlet and the second outlet and traverse the second stacked battery element through the cooling paths.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a perspective view of construction of a secondary battery module according to a first embodiment of the invention;

FIG. 2 illustrates a plan view of the battery module of FIG. 1, schematically showing an operation of the battery module;

FIG. 3 illustrates a plan view of a battery module according to a second embodiment of the present invention, schematically showing an operation of the battery module; and

FIG. 4 illustrates a block diagram schematically showing a battery module as a power source for driving a motor.

### DETAILED DESCRIPTION OF THE INVENTION

Korean Patent Application No. 10-2004-0099307, filed on Nov. 30, 2004, in the Korean Intellectual Property Office, and entitled: “Secondary Battery Module,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration. Like reference numerals refer to like elements throughout.

A battery module according to the present invention may enable the volume of the battery module to be minimized by improving the arrangement structure of unit batteries therein. Further, the cooling efficiency of the battery module may be enhanced, and the cooling medium may be evenly circulated between the unit batteries, such that temperature variations over the entire battery module may be reduced or eliminated.

A battery module according to the present invention may be used in high-power applications, e.g., as a power source for driving a motor of an apparatus such as a hybrid electric vehicle (HEV), an electric vehicle (EV), a wireless, i.e., rechargeable, cleaner such as a vacuum, an electric bicycle, an electric scooter, etc.

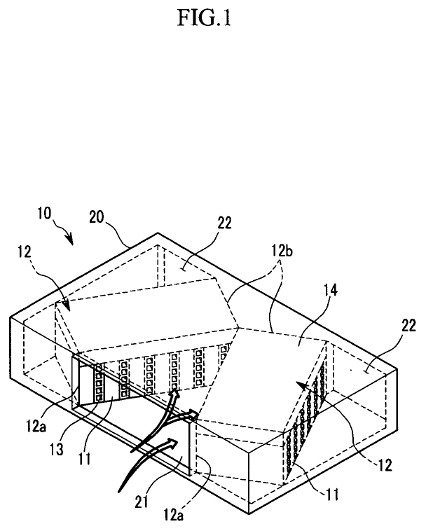

FIG. 1 illustrates a perspective view of construction of a secondary battery module according to a first embodiment of the invention. Referring to FIG. 1, a battery module 10 may include one or more battery columns 12, each composed of a plurality of unit batteries 11 arranged at predetermined intervals, e.g., laminated or stacked together in the form of a stacked battery element. Unit batteries 11 may be primary or secondary batteries and may be, e.g., prismatic secondary batteries. Battery partition walls 13 may be alternately disposed between the unit batteries 11 to provide channels, or flow paths, whereby a cooling medium can cool the unit batteries. The flow paths may be substantially perpendicular to the length of the battery column 12, i.e., the cooling medium may traverse the battery column 12 at a right angle. In the case of a battery column 12 having three or more unit batteries 11, a portion of the battery column 12 may include, serially arranged, a first unit battery 11, a first partition wall 13, a second unit battery 11, a second partition wall 13, and a third unit battery 11.

In addition, a system circuit part 14, which electrically connects the respective terminals of the laminated unit batteries 11, may be disposed on a terminal side of the unit batteries and may be formed as, e.g., a molded structure. The battery column 12 may have a regular rectangular shape and may have a rectangular cross-section, which may be a substantially square cross-section. In the description that follows, two battery columns 12 will be described, although this is merely for ease of explanation and the present invention may include one, two, three, etc., battery columns.

The battery module 10 may also include a housing 20 having an inlet 21 and an outlet 22 and in which the battery column 12 is disposed and arranged at an angle to the direction of the cooling medium entering the inlet 21. The housing may have a regular shape, e.g., a rectangular or box-like shape, the walls of which may be disposed at right angles to, or normal to, one another. The inlet 21 and the outlet 22 are provided for circulating the cooling medium through the battery column 12, i.e., between the respective unit batteries 11. Thus, the battery column 12 may be disposed in a cooling medium flow path defined between the inlet 21 and the outlet 22, such that the cooling medium traverses the battery column 12. The cooling medium flow path may be convoluted, i.e., may not exhibit a straight-line path, between the inlet 21 and outlet 22, due to the battery column 12 being disposed at an angle with respect to the direction of the cooling medium as it enters inlet 21. The cooling medium may be, e.g., air, and, in the description that follows, air will be used as an exemplary cooling medium. However, the present invention is equally suited to other cooling media and air will be referred to merely for ease of explanation.

As illustrated in FIG. 1, the battery module 10 may include two battery columns 12 arranged at an angle with respect to an inflow direction of the cooling air, i.e., arranged at an angle with respect to the inlet 21. The two battery columns 12 may be arranged at an angle with respect to each other, such that rear ends 12b, adjacent to the outlet 22, converge. Corners of the rear ends 12b of the battery columns 12 may abut each other. Front ends 12a of the battery columns 12 may be more widely spaced than the rear ends 12b and may be disposed adjacent to the inlet 21.

The housing 20 may be formed in a regular shape, e.g., a rectangular or box shape, and may constitute the external portion of the battery module 10. The inlet 21 may be disposed in a front side of the housing 20, and the outlet 22 may be disposed in a rear side of the housing 21.

Two battery columns 12 may be inclined or angled at a predetermined angle with respect to each other and may be disposed on the same surface in the housing 20. That is, the battery columns 12 may be disposed inclined toward each other, and may be disposed such that a corner of the front end 12a abuts an inner wall of the housing 20.

The battery columns 12 may be inclined with respect to each other at an angle in the range of about 5° to about 170°. If the angle is less than about 5°, it may be difficult for cooling air to uniformly flow in between the battery partition walls 13. However, if the angle is greater than about 170°, the volume of the battery module 10 may become unsuitably large.

When two battery columns 12 are present and disposed at an angle as shown in FIG. 1, the front ends 12a of the two battery columns 12 may be separated from each other near the inlet 21, and corners of the rear ends 12b of the battery columns 12 may be adjacent to or abut one other.

The inlet 21 may be formed in a front surface of the housing 20, e.g., at a center portion thereof. The width of the inlet 21 may be sized to correspond to the length between the corners of the front ends 12a of the battery columns 12. That is, where two battery columns 12 are disposed at an angle, e.g., in the inverted V configuration illustrated in FIG. 1, the width of the inlet 21 may be roughly equal to the space between the battery columns 12 at the opening of the V.

The outlet 22 may be formed at a rear surface of the housing 20, e.g., laterally disposed towards one side. Where two outlets 22 are provided, e.g., as illustrated in FIG. 1, they may be spaced apart on opposing regions of the housing 20, with the rear ends 12b of the battery columns 12 disposed between the two outlets 22. The outlet 22 may be arranged and sized such that air, having passed through the battery column 12, may easily exit the housing 20. The width of the outlet 22 may have a size corresponding to a distance between an inner wall of the housing 20 and a corner of the battery column 12 at the rear end 12b.

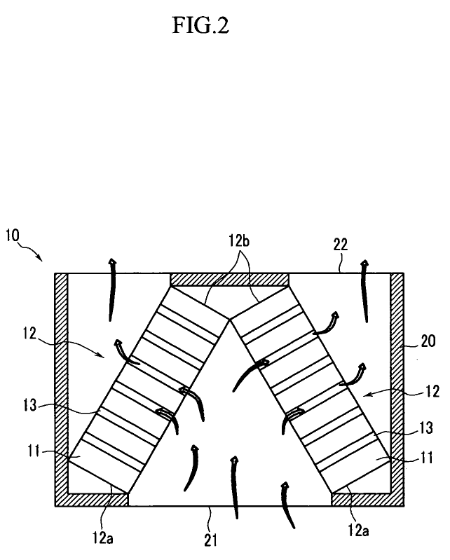

FIG. 2 illustrates a plan view of the battery module of FIG. 1, schematically showing an operation of the battery module. In operation, cooling air flows into the housing 20 through the inlet 21 and flows in between the front ends 12a of the battery columns 12. The front ends 12a are spaced apart due to the angular arrangement of the battery columns 12. Cooling air then passes through the battery partition walls 13 between the unit batteries 11 of the respective battery columns 12, thus individually cooling the battery columns 12. The cooling air, having passed through the battery columns 12, exits toward respective outlets 22, which may be disposed toward the respective side edges of the housing 20. Accordingly, in contrast to conventional battery modules, the battery module of the present invention may provide fresh cooling air to each of the respective battery columns 12, rather than, e.g., only to a first battery column in a series of parallel battery columns.

The battery column 12 may be inclined at a predetermined angle with respect to the direction of the cooling air flowing into the housing via the inlet 21. Thus, a battery module according to the present invention may provide for smooth circulation of cooling air along the battery partition walls 13 between the inclined unit batteries 11. As the cooling air progresses through the battery partition walls 13, it cools the unit batteries 11 of the respective battery columns 12, after which it progresses to the outlet 22 through a gap defined between the battery column 12 and the inner wall of the housing 20, so as to exit from the housing 20.

The cooling air which flows in the housing 20, as described above, may flow in between two battery columns 12, which are arranged at a predetermined degree, so that a portion of the cooling air circulates through one battery column 12 and another portion circulates through the other battery column 12, thereby allowing fresh cooling air to pass through two battery columns 12 simultaneously. The two battery columns 12 may be disposed in the housing such that the only flow paths for the cooling air are flow paths that traverse one or the other of the two battery columns 12.

Accordingly, although a pair of the battery columns 12 are arranged lengthwise on the same surface of the housing 20, so as to minimize the height of the battery module 10, cooling efficiency can be maintained or enhanced by circulating fresh cooling air through the pair of battery columns 12 simultaneously, and the unit batteries 11 of the respective battery columns 12 may be more uniformly cooled.

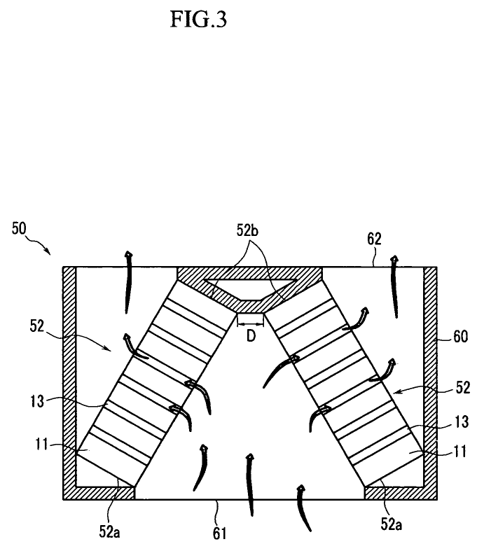

FIG. 3 illustrates a plan view of a battery module according to a second embodiment of the present invention, schematically showing an operation of the battery module. Referring to FIG. 3, a battery module 50 according to the second embodiment may include at least two battery columns 52, which may be arranged at an angle with respect to the inflow direction of cooling air flowing into the housing 60. Rear ends 52b may be disposed adjacent to an outlet 62 and may be separated from each other by a distance D. That is, according to this embodiment of the present invention, front ends 52a and the rear ends 52b may both be spaced apart. The front ends 52a, which are disposed adjacent to an inlet 61, may be separated from each other by a larger distance than the distance D between the rear ends 52b.

The velocity of the air that flows in the housing 60 may become smaller as the air progresses toward the rear end 52b of the battery column 52. Accordingly, the flow of cooling air to a battery partition wall 13 positioned toward the rear end 52b may be smaller than the flow of cooling air to a battery partition wall 13 positioned toward the front end 52a of the battery column 52. Therefore, it may be desirable to increase the amount of cooling air available to a unit battery 11 positioned toward the rear end 52b.

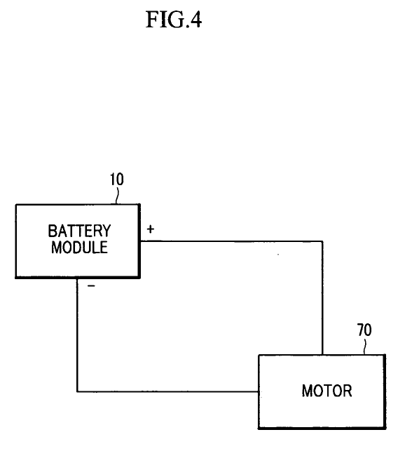

FIG. 4 is a block diagram schematically showing a state in which the battery module 10 shown in FIG. 1 is connected to a motor 70.

According to this embodiment of the present invention, the flow of cooling air available along the rear ends 52b may be improved by separating the rear ends 52b by the distance D. When the rear ends 52b of the battery columns 52 are somewhat separated from each other as described, a larger quantity of cooling air may be provided to the rear ends 52b, so as to more uniformly cool the battery columns 52.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A battery module, comprising,
a housing and a battery column disposed in the housing,
wherein the housing includes a cooling medium inlet and a cooling medium outlet,
the battery column includes a plurality of unit batteries and at least one cooling medium flow path, and
the battery column is arranged at an angle with respect to the cooling medium inlet.

2. The battery module as claimed in claim 1, wherein the unit batteries are spaced apart and have the cooling medium flow path disposed therebetween.

3. The battery module as claimed in claim 2, wherein the battery column includes at least three unit batteries and at least two cooling medium flow paths arranged alternately, such that the unit batteries and the cooling medium flow paths form a column that includes alternating unit batteries and cooling medium flow paths.

4. The battery module as claimed in claim 2, wherein the battery column is disposed between the cooling medium inlet and the cooling medium outlet, such that any cooling medium flowing from the cooling medium inlet to the cooling medium outlet must flow through the at least one cooling medium flow path.

5. The battery module as claimed in claim 1, further comprising battery partition walls disposed between each of the plurality of unit batteries.

6. The battery module as claimed in claim 1, wherein the battery columns are disposed on a same surface.

7. The battery module as claimed in claim 6, wherein the battery columns are disposed between and are in contact with two opposing surfaces of the housing.

8. The battery module as claimed in claim 1, wherein the cooling medium outlet has a size corresponding to a distance between an inner wall of the housing and a corner of the battery column.

9. The battery module as claimed in claim 1, further comprising a second battery column, wherein the two battery columns are disposed inclined towards each other.

10. The battery module as claimed in claim 9, wherein an angle between the battery columns is in the range of about 5° to about 170°.

11. The battery module as claimed in claim 9, wherein:
each battery column has a first end and a second end,
the first ends of the battery columns are spaced farther apart than the second ends of the battery columns, and
the cooling medium inlet is disposed adjacent to and between the first ends of the battery columns.

12. The battery module as claimed in claim 11, wherein the cooling medium inlet has a first dimension approximately equal to the space between the first ends of the battery columns.

13. The battery module as claimed in claim 11, further comprising a second cooling medium outlet, wherein:
the two cooling medium outlets have the two battery columns disposed therebetween, and
each battery column is disposed between a cooling medium outlet and the cooling medium inlet, such that any cooling medium flowing from the cooling medium inlet to either of the two cooling medium outlets must flow through at least one of the battery columns.

14. The battery module as claimed in claim 11, wherein the second ends of the two battery columns are disposed directly adjacent to each other.

15. The battery module as claimed in claim 11, wherein the second ends of the two battery columns are disposed apart from each other by a first distance.

16. The battery module as claimed in claim 1, wherein the unit battery is a prismatic battery.

17. The battery module as claimed in claim 1, wherein the battery module is for a motor driven device.

18. A battery module, comprising a stacked battery element disposed in a housing, wherein:
the stacked battery element has a substantially rectangular cross section, the cross section having a height and a width, and includes:
a plurality of unit batteries; and
cooling paths disposed between adjacent unit batteries, the housing encloses the stacked battery element and includes:
first and second inner surfaces which are disposed adjacent to opposing surfaces of the cross section and are separated by the height;
third and fourth inner surfaces normal to the first and second inner surfaces and separated by a distance that is larger than the width; and
an inlet and an outlet, and
the stacked battery element is disposed at an angle between the inlet and the outlet, such that a cooling medium flow path traversing the stacked battery element through the cooling paths does not form a straight line between the inlet and the outlet.

19. The battery module as claimed in claim 18, wherein:
the housing further includes a second outlet,
the battery module further includes a second stacked battery element disposed in the housing and arranged at an angle to the other stacked battery element, and
a second flow path is defined between the inlet and the second outlet and traverses the second stacked battery element through the cooling paths.
